(19) United States
(12) Patent Application Publication
(10) Pub. No.: US 2009/0063578 A1
(43) Pub. Date: Mar. 5, 2009

(54) MANAGEMENT OF DATA NEEDED TO RESOLVE POINTER ERRORS IN HEIRARCHICAL DATABASE MANAGEMENT SYSTEMS

(75) Inventors: Dario D'ANGELO, Los Gatos, CA (US); Charles E. JONES, Antioch, CA (US); Alan Ray SMITH, Gilroy, CA (US)

Correspondence Address: IBM ST-SVL;SAWYER LAW GROUP LLP, 2465 E. Bayshore Road, Suite No. 406, PALO ALTO, CA, 94303, US

(73) Assignee: INTERNATIONAL BUSINESS MACHINES CORPORATION, Armonk, NY (US)

(21) Appl. No.: 11/845,710

(22) Filed: Aug. 27, 2007

(51) Int. Cl. G06F 17/30

(52) U.S. Cl. 707/202; 707/E17.007

(57) ABSTRACT

A method for managing data needed to resolve pointer errors is provided. The method provides for receiving information concerning a pointer error, preparing the information received, submitting a job to select, sort, and format a subset of log and/or trace records such that the subset of records can be analyzed to resolve the pointer error.

### FIELD OF THE INVENTION

The present invention relates generally to management of data needed to resolve pointer errors in hierarchical database management systems.

### BACKGROUND OF THE INVENTION

When pointer errors are discovered in a hierarchical database management system, a customer (e.g., a company utilizing the hierarchical database management system) typically has to gather large volumes of data (e.g., log records, trace records, or the like) that may be at various locations, store all of the data in one location where it will be easily accessible, and then send (e.g., transmit via FTP) all of the data to technical support (e.g., technical support may be provided by a vendor of the hierarchical database management system) so that technical support can analyze the data and resolve the pointer errors. This requires both the customer and technical support to dedicate substantial hardware resources (e.g., storage space, bandwidth, and so forth) to resolving pointer errors, which is inefficient, time consuming, and expensive.

### SUMMARY OF THE INVENTION

A method for managing data needed to resolve pointer errors in hierarchical database management systems is provided. The method provides for receiving information concerning a pointer error, preparing the information received, and submitting a single job to select, sort, and format a subset of records such that the subset of records can be analyzed to resolve the pointer error. Collection of information enabling pointer error analysis may be accomplished using a single screen panel.

### BRIEF DESCRIPTION OF THE DRAWINGS

FIG. 1 depicts a process for managing data needed to resolve pointer errors according to an implementation of the invention.

FIG. 2 illustrates a system for managing data needed to resolve pointer errors according to an implementation of the invention.

FIG. 3 shows a sample screenshot of a single screen panel in which information relating to a pointer error can be entered according to an implementation of the invention.

FIG. 4 depicts a block diagram of a data processing system with which implementations of the invention can be implemented.

FIG. 5 illustrates a block diagram of a computer system with which implementations of the invention can be implemented.

### DETAILED DESCRIPTION

The present invention generally relates to management of data needed to resolve pointer errors in hierarchical database management systems. The following description is presented to enable one of ordinary skill in the art to make and use the invention and is provided in the context of a patent application and its requirements. The present invention is not intended to be limited to the implementations shown, but is to be accorded the widest scope consistent with the principles and features described herein.

In hierarchical database management systems, such as Information Management System (IMS) from International Business Machines Corporation of Armonk, N.Y., relationships (e.g., parent-child, sibling, etc.) between segments (e.g., pieces of data) are established through pointers. When a pointer is no longer pointing where it should be pointing (e.g., off in space, at a wrong segment, or the like), a pointer error has occurred. Pointer errors may result from, for example, a program (e.g., application, utility, process, tool, task, and so forth) failing while it is in the process of deleting a pointer.

Discovery of a pointer error usually does not coincide with occurrence of the pointer error because there are only a few ways to find pointer errors. A pointer error may be found when an attempt is made to access a segment via a pointer that should be, but is no longer pointing to the segment. A program that is designed to search for pointer errors can also be executed to look for pointer errors. An abnormal end (sometimes referred to as an abend) of a program may also lead to the discovery of a pointer error.

Since, it may be hard to pinpoint exactly when a pointer error occurred in a hierarchical database management system by the time the pointer error is discovered, a customer of the hierarchical database management system (e.g., a company utilizing the hierarchical database management system) will typically send a large amount of data including, for instance, log records, trace records, or the like, to technical support for the hierarchical database management system.

Technical support for the hierarchical database management system may be provided by a vendor of the hierarchical database management system, a third party, or some other entity. Once technical support receives the data from the customer, the data will be analyzed to find a resolution for the pointer error. Hence, both the customer and technical support are required to have a significant amount of resources available.

On the customer-side, it will take time for the customer to gather all of the data as the data may be on different systems (e.g., when a hierarchical database is shared by multiple systems) and the amount of data to be gathered may be hundreds of gigabytes. In addition, the customer will need to store the data gathered in one location where it can be easily accessed, such as a direct access storage disk (DASD) unit. The customer will then need bandwidth to transmit the data to technical support.

On the technical support-side, technical support will need bandwidth to receive the data being transmitted by the customer and storage space to store the data received. Additionally, it will take time for technical support to select (e.g., extract, filter, etc.) a subset of relevant data from the large amount of data sent by the customer, sort the subset of relevant data, format the subset of relevant data, and so forth before technical support can even attempt to resolve the pointer error.

Further, current methodologies require use of various programs to select, sort, format, and so forth log/trace records. As a result, different jobs (e.g., programs running in the background) may need to be submitted via different screen panels (e.g., interfaces). This requires knowledge of an order in which the different jobs should be submitted. Manual pointer calculations (e.g., calculating a block containing a pointer of interest) may also need to be performed. In addition, results from one job may need to be transferred to another job for additional processing. Moreover, it is inconvenient and time consuming having to go to one screen panel, enter information necessary to submit a job, wait for a result to be outputted, then take the outputted result, go to another screen panel, enter information necessary submit another job, and so on.

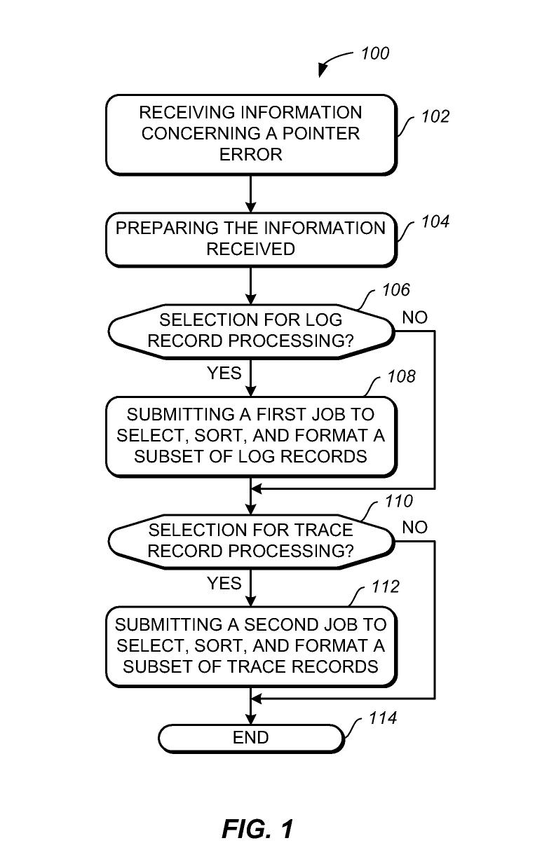

Depicted in FIG. 1 is a process 100 for managing (e.g., collecting, gathering, selecting, filtering, sorting, merging, formatting, organizing, etc.) data needed to resolve pointer errors in hierarchical database management systems according to an implementation of the invention. At 102, information concerning a pointer error in a hierarchical database management system is received. The pointer error involves a pointer in a hierarchical database managed by the hierarchical database management system. In one implementation, the information received concerning the pointer error is entered via a single screen panel or a single data entry process.

The information received may include an identifier of the hierarchical database, an identifier of a dataset in the hierarchical database containing the pointer, an address of the pointer, a size of blocks in the hierarchical database, a type of the hierarchical database, an access method of the hierarchical database, a time period, a name for each of a plurality of log records, a name for each of a plurality of trace records, a selection for log record processing, and/or a selection for trace record processing.

In one implementation, the name for each of the plurality of log records is listed in a partition data set member. Thus, rather than providing a name for each of the plurality of log records, a name of the partition data set member can be provided instead.

The name for each of the plurality of trace records may similarly be listed in a partition data set member. Hence, a name of the partition data set member can be provided in lieu of a name for each of the plurality of trace records. One partition data set member may be used to list the names of both sets of data (i.e., the plurality of log and the plurality of trace records).

At 104, the information received is prepared. For example, an identifier for a block of data in the hierarchical database that contains the pointer may be calculated. A block identifier may need to be calculated because some log/trace records may only indicate a block of data in the hierarchical database in which a particular record concerns. Hence, simply having the address of a pointer may not be enough to identify records involving the pointer.

Calculation of a block identifier is based on the size of blocks in the hierarchical database and the access method of the hierarchical database in one implementation. For example, if the access method of the hierarchical database is VSAM (Virtual Storage Access Method), then the block identifier will be in the form of a block or control interval range. In one implementation, a block or control interval range is calculated using the following formula:

block/control interval=(block address of pointer/block size)*block size

The range of the block/control interval will then be between the block/control interval calculated and a sum of the block/control interval calculated plus the block size. If the access method of the hierarchical database is instead OSAM (Overflow Sequential Access Method), then the block identifier will be in the form of a relative block number. In one implementation, a relative block number is calculated using the following formula:

relative block number=block address of pointer/block size

A selection for log record processing and a selection for trace record processing may be included in the information received because only log records may need to be processed or only trace records may need to be processed. For example, when no trace records are available, a selection for trace record processing need not be included in the information received. Similarly, the information received will not include the name of any trace record data set.

At 106, a determination is made as to whether a selection for log record processing is included in the information received. The selection for log record processing may be, for example, a radial button being selected, a checkbox being checked, a letter Y being inputted, or the like. When log record processing has been selected, a first job is submitted at 108 to select a subset of the plurality of log records, sort the subset of log records in chronological order, and format the subset of log records into human readable form.

Selection of the subset of log records may be based on whether a log record is a particular type of log record, whether a log record involves the pointer, whether a log record involves the block containing the pointer (e.g., whether the log record specifies the block identifier, whether the log record specifies an address within the block identifier or within a range of the block identifier, and so forth), whether a log record involves the hierarchical database, whether a log record involves the dataset containing the pointer, and/or whether a log record is within the time period included in the information received. A database type (e.g., fast path) may be specified in the information received because log/trace record format may differ depending on database type.

Some hierarchical databases will be divided into multiple datasets. As such, an identifier of a dataset in a hierarchical database containing a pointer of interest may need to be included in the information received. However, if a hierarchical database has only a single dataset, then a dataset identifier may not be necessary. Alternatively, when a hierarchical database has only one dataset, a default dataset identifier (e.g., 1, 01, and the like) may be included in the information received.

A time period may also be specified in the information received to limit which log/trace records are analyzed because although the log/trace records named is already limited to a particular time period, that particular time period may be much larger than the time period specified in the information received. Specifically, to ensure that no record that could possibly help to resolve a pointer error is left out, all records from a time in which it was last confirmed that the pointer had no error to a time in which the pointer error was discovered will usually be named in the information received.

Thus, the time period covering the log/trace records named in the information received could be quite large. If, after all of the log/trace records have already been, for instance, listed in a partial data set member, additional information comes to light that helps narrow down a time period in which the pointer error could have occurred, then it may be easier to simply specify a time period rather than go back and delete the names of log/trace records not within the narrower time period.

Once the subset of log records has been selected, the log records in the subset are then sorted in chronological order. When a pointer error is found in a hierarchical database shared by multiple systems, the subset of log records may include log records from different systems that are organized by system. Hence, sorting the subset of log records in chronological order may also include merging log records from different systems sharing the hierarchical database.

Log records may include data that is only readable by a machine. As such, the subset of log records selected will also need to be formatted (e.g., translated) into human readable form. Formatting may occur before or after sorting of the subset of log records. In one implementation, the first job also includes outputting a report based on the sorted and formatted subset of log records. The report can then be used for analyzing and resolving the pointer error.

When it is determined at 106 that log record processing has not been selected or after the first job is submitted at 108, a determination is made at 110 as to whether a selection for trace record processing is included in the information received. The selection for trace record processing can also be, for example, a radial button being selected, a checkbox being checked, a letter Y being inputted, or the like. If trace record processing has been selected, a second job is submitted at 112 to select a subset of the plurality of trace records, sort the subset of trace records in chronological order, and format the subset of trace records into human readable form.

Similar to the selection of the subset of log records, selection of the subset of trace records may be based on whether a trace record is a particular type of trace record, whether a trace record involves the pointer, whether a trace record involves the block containing the pointer, whether a trace record involves the hierarchical database, whether a trace record involves the dataset containing the pointer, and/or whether a trace record is within the time period included in the information received.

As with the first job, the second job may also include outputting a report based on the sorted and formatted subset of trace records, which can then be used to analyze and resolve the pointer error. In one implementation, the first job and second job are combined into a single job.

Regardless of whether the first job and second job are combined or not, a single report based on the sorted and formatted subset of log records and the sorted and formatted subset of trace records may be outputted rather than two reports. This can be done by not having the first job and the second job output any report and adding a process block (not shown) to process 100 in which a single report based on the sorted and formatted subset of log and trace records is outputted.

Process 100 may have another process block (not shown) of sending (e.g., transmitting) one or more reports to technical support to find a solution to the pointer error. The report may be sent by, for instance, FTP (File Transfer Protocol) or other means. When it is determined at 110 that trace record processing has not been selected or after the second job is submitted at 112, process 100 ends at 114.

By providing a single screen panel in which information relating to a pointer error can be entered and only one or two jobs are automatically initiated to select, sort, and format log or trace records needed to resolve the pointer error, management of data needed to resolve pointer errors is greatly simplified. There will no longer be a need to go from screen panel to screen panel or submit a group of jobs to select, sort, and filter log records and another group of jobs to select, sort, and filter trace records.

In addition, data can now be selected, sorted, formatted, and so forth at a customer site before being sent to technical support. This will significantly reduce the amount of data that has to be stored at and transmitted between the customer and technical support. Further, once technical support receives the data from the customer, technical support will be able to immediately begin analyzing the pre-filtered/pre-processed/pre-selected data, identifying causes, and designing fixes to resolve the pointer error. This will greatly reduce the total problem resolution elapsed time (e.g., detection of pointer error to resolution of pointer error) from days to hours or even from hours to minutes.

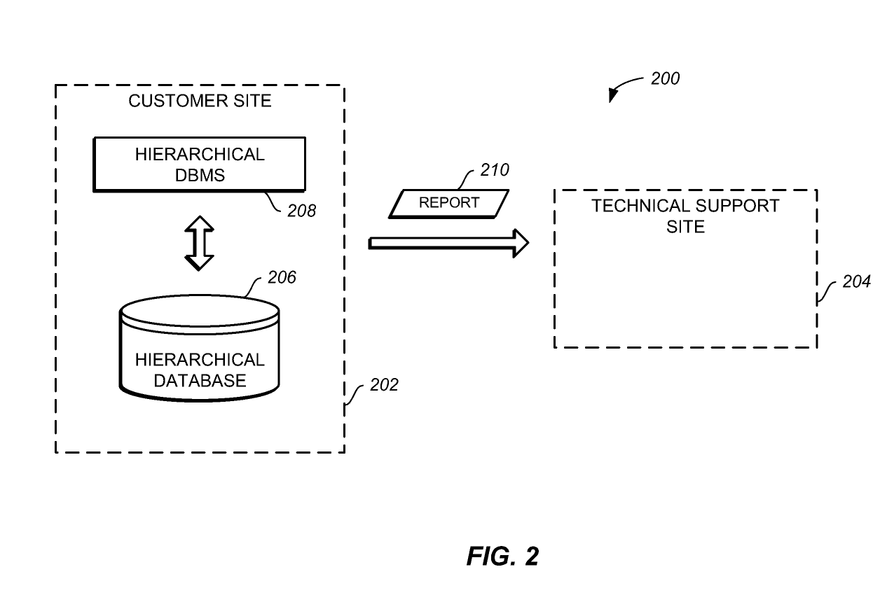

FIG. 2 illustrates a system 200 for managing data needed to resolve pointer errors according to an implementation of the invention. System 200 includes a customer site 202 and a technical support site 204. A hierarchical database 206 is located at customer site 202, which is managed by a hierarchical database management system (HDBMS) 208. Multiple computer systems (not shown) may be located at customer site 202, each of which may be running a separate HDBMS 208 that is sharing access to hierarchical database 206. Technical support site 204 may be a site of a vendor of HDBMS 208 that is providing technical support to customer site 202.

In the implementation, process 100 in FIG. 1 is performed by HDBMS 208. Process 100 may be implemented as a tool in HDBMS 208, an option in HDBMS 208, or something else. If customer site 202 includes multiple computer systems, each running a separate HDBMS 208, then multiple instances of process 100 may need to be executed depending on whether a single HDBMS 208 has access to all of the log/trace records. In FIG. 2, once HDBMS 208 completes processing (e.g., selecting, sorting, formatting, etc.) log/trace records, a report 210 is sent to technical support site 204 to find a resolution for one or more pointer errors.

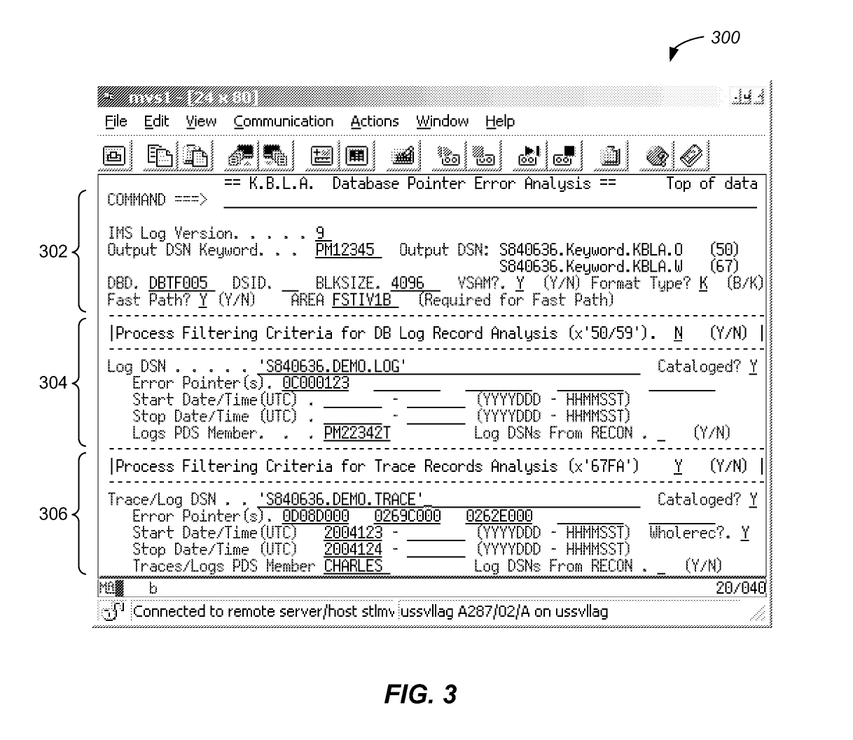

Shown in FIG. 3 is a sample screenshot of a single screen panel 300 in which information relating to a pointer error can be entered according to an implementation of the invention. Single screen panel 300 has three sections, a common section 302, a log section 304, and a trace section 306.

In common section 302, there is a field ‘DBD’ for a database identifier to be entered, a field ‘DSID’ for a dataset identifier to be entered, a field ‘BLKSIZE’ for a block size to be entered, a field ‘VSAM’ for an access method to be entered, and a field ‘Fast Path’ for a database type to be entered.

In log section 304, there is a field ‘Process Filtering Criteria for DB Log Record Analysis’ for a log record processing selection to be entered, a field ‘Error Pointer(s)’ for pointer addresses to be entered, fields ‘Start Date/Time’ and ‘Stop Date/Time’ for a time period to be entered, and a field ‘Logs PDS Member’ for a name of a partition data set member to be entered, which will include a list of names for log records to be processed. In FIG. 3, although a pointer address has been entered along with a partition data set member, log record processing will not occur as an ‘N’ has been entered in the ‘Process Filtering Criteria for DB Log Record Analysis’ field.

Trace section 306 looks very similar to log section 304, except it relates to traces rather than logs. In trace section 306, there is a field ‘Process Filtering Criteria for Trace Records Analysis’ for a trace record processing selection to be entered, a field ‘Error Pointer(s)’ for pointer addresses to be entered, fields ‘Start Date/Time’ and ‘Stop Date/Time’ for a time period to be entered, and a field ‘Logs PDS Member’ for a name of a partition data set member to be entered, which will include a list of names for trace records to be processed. In FIG. 3, trace record processing will proceed as a ‘Y’ has been entered in the ‘Process Filtering Criteria for Trace Records Analysis’ field.

As shown in FIG. 3, more than one pointer error can be analyzed at the same time (e.g., addresses of pointers having errors ‘0D08D000’, ‘0269C000’, and ‘0262E000’ have been entered in the ‘Error Pointer(s)’ field of trace section 306). However, when more than one pointer error is to be evaluated at the same time, all of the pointer errors must involve pointers in a single hierarchical database and in only one dataset of the hierarchical database.

The invention can take the form of an entirely hardware implementation, an entirely software implementation, or an implementation containing both hardware and software elements. In one aspect, the invention is implemented in software, which includes, but is not limited to, application software, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include DVD, compact disk-read-only memory (CD-ROM), and compact disk-read/write (CD-R/W).

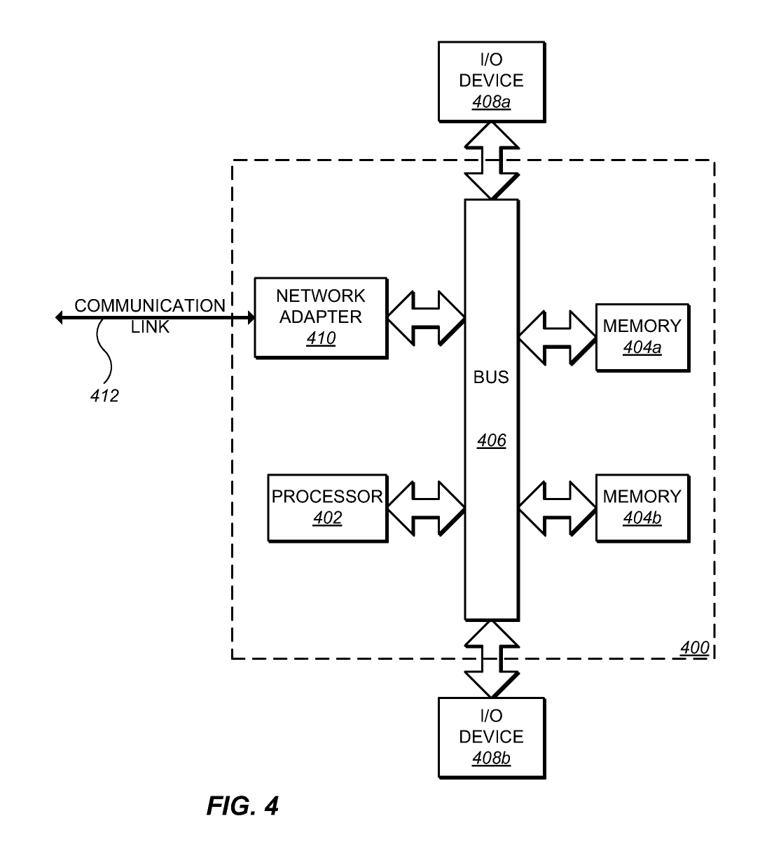

FIG. 4 depicts a data processing system 400 suitable for storing and/or executing program code. Data processing system 400 includes a processor 402 coupled to memory elements 404a-b through a system bus 406. In other implementations, data processing system 400 may include more than one processor and each processor may be coupled directly or indirectly to one or more memory elements through a system bus.

Memory elements 404a-b can include local memory employed during actual execution of the program code, bulk storage, and cache memories that provide temporary storage of at least some program code in order to reduce the number of times the code must be retrieved from bulk storage during execution. As shown, input/output or I/O devices 408a-b (including, but not limited to, keyboards, displays, pointing devices, etc.) are coupled to data processing system 400. I/O devices 408a-b may be coupled to data processing system 400 directly or indirectly through intervening I/O controllers (not shown).

In the implementation, a network adapter 410 is coupled to data processing system 400 to enable data processing system 400 to become coupled to other data processing systems or remote printers or storage devices through communication link 412. Communication link 412 can be a private or public network. Modems, cable modems, and Ethernet cards are just a few of the currently available types of network adapters.

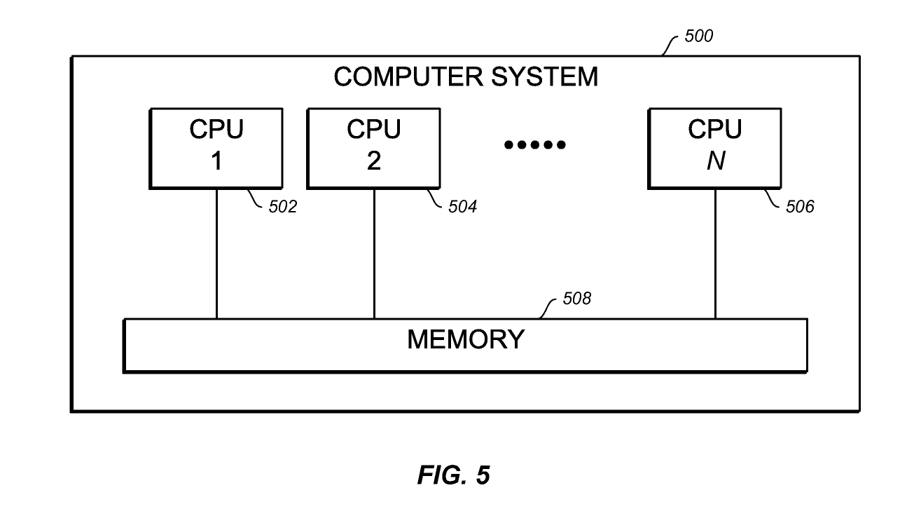

Illustrated in FIG. 5 is a computer system 500, such as the S/390 mainframe computer system from International Business Machines Corporation of Armonk, N.Y. Computer system 500 includes one or more central processing units (CPUs) 502, 504, and 506. CPUs 502-506 operate together in concert with a memory 508 in order to execute a variety of tasks. Other components may be utilized with computer system 500, such as input/output devices comprising direct access storage devices (DASDs), printers, tapes, and so forth (not shown).

While various implementations for managing data needed to resolve pointer errors in hierarchical database systems have been described, the technical scope of the present invention is not limited thereto. For example, the present invention is described in terms of particular systems having certain components and particular methods having certain steps in a certain order. One of ordinary skill in the art, however, will readily recognize that the methods described herein can, for instance, include additional steps and/or be in a different order, and that the systems described herein can, for instance, include additional or substitute components. Hence, various modifications or improvements can be added to the above implementations and those modifications or improvements fall within the technical scope of the present invention.

What is claimed is:

1. A method for managing data needed to resolve pointer errors in hierarchical database management systems, the method comprising:
receiving information concerning a pointer error, the pointer error involving a pointer in a hierarchical database, the information received including one or more of
an identifier of the hierarchical database,
an identifier of a dataset in the hierarchical database containing the pointer,
an address of the pointer,
a size of blocks in the hierarchical database,
a type of the hierarchical database,
an access method of the hierarchical database,
a time period,
a name for each of a plurality of log records,
a name for each of a plurality of trace records,
a selection for log record processing, and
a selection for trace record processing;
preparing the information received, wherein preparing the information received comprises
calculating an identifier for a block in the hierarchical database containing the pointer;
responsive to the selection for log record processing being included in the information received, submitting a first job to
select a subset of the plurality of log records,
sort the subset of log records in chronological order, and
format the subset of log records into human readable form; and
responsive to the selection for trace record processing being included in the information received, submitting a second job to
select a subset of the plurality of trace records,
sort the subset of the trace records in chronological order, and
format the subset of trace records into human readable form,
wherein the information received is entered by a user via a single screen panel.

2. The method of claim 1, wherein
selection of the subset of log records is based on one or more of
whether a log record is a particular type of log record,
whether a log record involves the pointer,
whether a log record involves the block containing the pointer,
whether a log record involves the hierarchical database,
whether a log record involves the dataset containing the pointer, and
whether a log record is within the time period included in the information received, and
selection of the subset of the trace records is based on one or more of
whether a trace record is a particular type of trace record,
whether a trace record involves the pointer,
whether a trace record involves the block containing the pointer,
whether a trace record involves the hierarchical database,
whether a log record involves the dataset containing the pointer, and
whether a trace record is within the time period included in the information received.

3. The method of claim 1, wherein
the name for each of the plurality of log records is listed in a first partition data set member and the information received includes a name of the first partition data set member, and
the name for each of the plurality of trace records is listed in a second partition data set member and the information received includes a name of the second partition data set member.

4. The method of claim 1, wherein the first job submitted in response to the selection for log record processing being included in the information received further
outputs a first report based on the sorted and formatted subset of log records for analyzing the pointer error.

5. The method of claim 1, wherein the second job submitted in response to the selection for trace record processing being included in the information received further
outputs a second report based on the sorted and formatted subset of trace records for analyzing the pointer error.
